(19) United States
(12) Patent Application Publication
(10) Pub. No.: US 2011/0122325 A1
(43) Pub. Date: May 26, 2011

(54) Display device, method of driving the display device, and electronic device

(75) Inventors: Junichi Yamashita, Tokyo (JP); Katsuhide Uchino, Kanagawa (JP)

(73) Assignee: Sony Corporation, Tokyo (JP)

(21) Appl. No.: 12/926,148

(22) Filed: Oct. 28, 2010

(30) Foreign Application Priority Data
Nov. 24, 2009 (JP) 2009-266735

(51) Int. Cl. H04N 5/66; G09G 5/00

(52) U.S. Cl. 348/739; 345/211; 348/E05.133

(57) ABSTRACT

A display device, which may achieve low power consumption without disturbing high resolution, a method of driving the display device, and an electronic device having the display device are provided. The display device includes: a display section having sets of light emitting elements and pixel circuits arranged two-dimensionally; and a drive section driving each of the pixel circuits based on a video signal. The pixel circuit has a dual-gate first transistor having a first gate and a second gate and controlling electric current flowing into each of the light emitting elements, and a second transistor writing a signal voltage into the first gate in accordance with the video signal. The drive section applies the signal voltage to the pixel circuit such that at least part of values of gate-to-source voltage of the first transistor in a usable range is 5 V or lower.

### BACKGROUND OF THE INVENTION

1. Field of the Invention

The present invention relates to a display device that displays an image by light emitting elements disposed for respective pixels, a method of driving the display device, and an electronic device having the display device.

2. Description of Related Art

Recently, a display device using a current-drive optical element as a light emitting element of a pixel has been developed and commercialized in a field of display devices for image display, the optical element being changed in emission luminance in accordance with a value of electric current flowing into the optical element, for example, an organic EL (Electro Luminance) element.

The organic EL element is a self-luminous element unlike a liquid crystal element or the like. Therefore, a display device using the organic EL element (organic EL display device) does not need a light source (backlight), and therefore the device is high in image visibility, low in power consumption, and high in response speed compared with a liquid crystal display device that needs a light source.

A drive method of the organic EL display device includes simple (passive) matrix drive and active matrix drive as in the liquid crystal display device. The former has a difficulty that a large display with high resolution is hardly achieved while a simple device structure is achieved. Therefore, the active matrix drive is being actively developed at present. In the active matrix drive, electric current flowing into an organic EL element disposed for each pixel is controlled by an active element (typically TFT (Thin Film Transistor)) within a pixel circuit provided for each organic EL element.

Generally, a current-voltage (I-V) characteristic of the organic EL element degrades with time (temporal degradation). In the pixel circuit that current-drives the organic EL element, when the I-V characteristic of the organic EL element is changed with time, a voltage-dividing ratio between the organic EL element and TFT connected in series to the organic EL element is accordingly changed, resulting in change in gate-to-source voltage V_{gs} of the TFT. As a result, a value of current flowing into the TFT is changed, resulting in change in value of current flowing into the organic EL element, and consequently emission luminance is changed in accordance with the changed current value.

In TFT, threshold voltage Vₜₕ or mobility μ may be temporally changed, or may vary for each pixel circuit due to variation in manufacturing process. When the threshold voltage Vₜₕ or mobility μ of TFT varies for each pixel circuit, a value of current flowing into TFT varies for each pixel circuit. As a result, even if the same voltage is applied to respective gates of TFTs, emission luminance varies among organic EL elements, leading to loss of screen uniformity.

Thus, a measure to correct the threshold voltage Vₜₕ or mobility μ of TFT has been proposed so that even if the I-V characteristic of the organic EL element is changed with time, or the threshold voltage Vₜₕ or mobility μ of TFT is changed with time, emission luminance of the organic EL element is not affected by such temporal change and thus kept constant (for example, see Japanese Unexamined Patent Application Publication No. 2008-083272).

### SUMMARY OF THE INVENTION

In a field of the organic EL display device, low power consumption is highly demanded as in the fields of other display devices. For example, as a measure to achieve low power consumption, it is considered that size of TFT is increased to reduce gate-to-source voltage V_{gs} of the TFT. However, such increase in size of TFT is against the trend of high resolution, and increase in size of TFT is therefore limited.

It is desirable to provide a display device that achieves low power consumption without disturbing high resolution, a method of driving the display device, and an electronic device having the display device.

A display device according to an embodiment of the invention includes a display section having sets of light emitting elements and pixel circuits arranged two-dimensionally, and a drive section driving each of the pixel circuits based on a video signal. The pixel circuit has two transistors (first transistor and second transistor). The first transistor is a dual-gate transistor including first and second gates, and controlling electric current flowing into each light emitting element. The second transistor writes a signal voltage into the first gate in accordance with the video signal. The drive section applies a signal voltage to the pixel circuit such that at least part of values of gate-to-source voltage of the first transistor in a usable range is 5 V or lower.

An electronic device according to an embodiment of the invention includes the above-mentioned display device.

A method of driving a display device according to an embodiment of the invention includes the following two steps:

(A) Preparing a display device having a configuration described below;

(B) Using a drive section to apply a signal voltage to the pixel circuit such that at least part of values of gate-to-source voltage of the first transistor in a usable range are 5 V or lower.

The display device applied with the driving method includes a display section having sets of light emitting elements and pixel circuits arranged two-dimensionally, and a drive section driving each of the pixel circuits based on a video signal. The pixel circuit has two transistors (first transistor and second transistor). The first transistor is a dual-gate transistor including first and second gates, and controlling electric current flowing into each light emitting element. The second transistor writes a signal voltage into the first gate in accordance with the video signal.

In the display device, the method of driving the display device, and the electronic device according to the embodiment of the invention, a signal voltage is applied to the pixel circuit such that at least part of values of gate-to-source voltage of the first transistor in a usable range are 5 V or lower. Thus, the gate-to-source voltage may be reduced without increasing size of the first transistor.

According to the display device, the method of driving the display device, and the electronic device of the embodiment of the invention, gate-to-source voltage of the first transistor may be reduced without increasing size of the first transistor. Thus, low power consumption may be achieved without disturbing high resolution.

Other and further objects, features and advantages of the invention will appear more fully from the following description.

### BRIEF DESCRIPTION OF THE DRAWINGS

FIG. 1 is a block diagram showing an example of a display device according to a first embodiment of the invention.

FIG. 2 is a block diagram showing an example of an internal configuration of a pixel circuit array section in FIG. 1.

FIG. 3 is a waveform diagram for illustrating an example of operation of the display device of FIG. 1.

FIGS. 4A and 4B are relationship diagrams, each diagram showing a relationship between gate-to-source voltage and electric current flowing into a light emitting element for each of dual-gate and bottom-gate transistors.

FIG. 5 is a relationship diagram showing a relationship between the gate-to-source voltage of either of the dual-gate and bottom-gate transistors and a current ratio between the transistors.

FIG. 6 is a plan diagram showing a schematic configuration of a module including the display device according to the embodiment.

FIG. 7 is a perspective diagram showing appearance of application example 1 of the display device according to the embodiment.

FIGS. 8A and 8B are perspective diagrams, where FIG. 10A shows appearance of application example 2 as viewed from a surface side, and FIG. 10B shows appearance thereof as viewed from a back side.

FIG. 9 is a perspective diagram showing appearance of application example 3.

FIG. 10 is a perspective diagram showing appearance of application example 4.

FIGS. 11A to 11G are diagrams, where FIG. 11A is a front diagram of application example 5 in an opened state, FIG. 11B is a side diagram thereof, FIG. 11C is a front diagram thereof in a closed state, FIG. 11D is a left side diagram thereof, FIG. 11E is a right side diagram thereof, FIG. 11F is a top diagram thereof, and FIG. 11G is a bottom diagram thereof.

### DETAILED DESCRIPTION OF THE PREFERRED EMBODIMENTS

Hereinafter, a preferred embodiment of the invention will be described in detail with reference to drawings. Description is made in the following sequence.

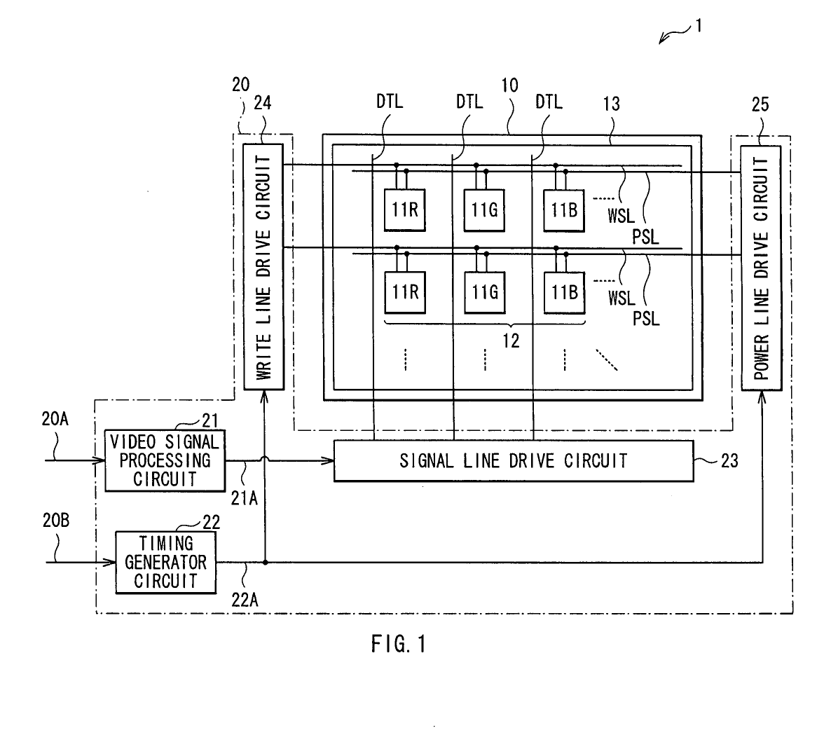

1. Embodiment (FIGS. 1 to 5): Example where a drive transistor is driven in a sub-threshold region

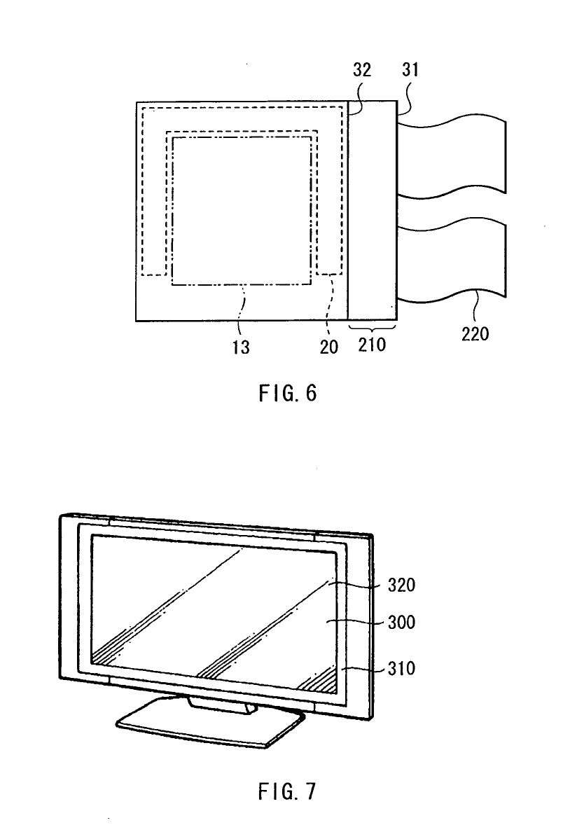

2. Module and application examples (FIGS. 6 to 11)

### Embodiment

Schematic Configuration of Display Device

FIG. 1 shows a schematic configuration of a display device 1 according to an embodiment of the invention. The display device 1 includes a display panel 10 (display section) and a drive circuit 20 (drive section). The display panel 10 has, for example, a pixel circuit array section 13 having a plurality of organic EL elements 11R, 11G and 11B (light emitting elements) arranged two-dimensionally. In the embodiment, for example, three organic EL elements 11R, 11G and 11B adjacent to one another configure one pixel 12. Hereinafter, a term, organic EL element 11, is appropriately used as a general term of the organic EL elements 11R, 11G and 11B. The drive circuit 20 drives the pixel circuit array section 13, and, for example, has a video signal processing circuit 21, a timing generator circuit 22, a signal line drive circuit 23, a write line drive circuit 24 and a power line drive circuit 25.

Pixel Circuit Array Section

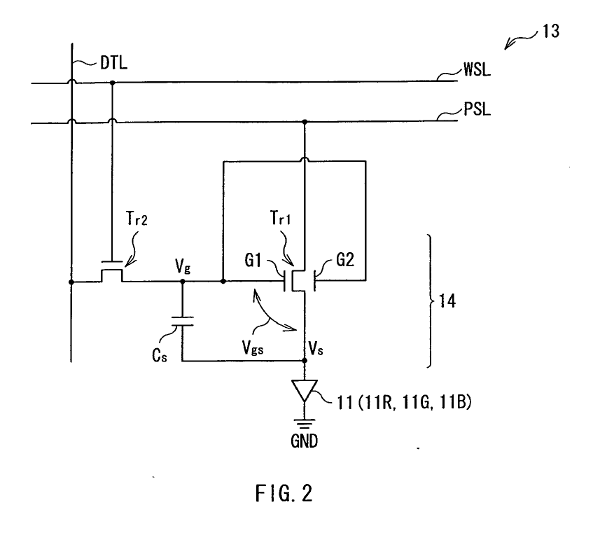

FIG. 2 shows an example of a circuit configuration of the pixel circuit array section 13. The pixel circuit array section 13 is formed in a display region of the display panel 10. The pixel circuit array section 13 has a plurality of write lines WSL disposed in rows, a plurality of signal lines DTL disposed in columns, and a plurality of power lines PSL disposed in rows along the write lines WSL, for example, as shown in FIGS. 1 and 2. Sets of organic EL elements 11 and pixel circuits 14 are disposed in rows and columns (two-dimensionally) in correspondence to respective intersections of the write lines WSL and the signal lines DTL. Each pixel circuit 14 is configured of, for example, a drive transistor Tr₁ (first transistor), a write transistor Tr₂ (second transistor), and a capacitance Cₛ, and thus has a configuration of 2Tr1C.

The drive transistor Tr₁ is formed of a dual-gate transistor having a top gate G1 (first gate) and a back gate G2 (second gate), and, for example, formed of an n-channel MOS thin-film transistor (TFT). The write transistor Tr₂ is formed of, for example, a dual-gate, top-gate, or bottom-gate transistor, and, for example, formed of an n-channel MOS TFT. The drive transistor Tr₁ or the write transistor Tr₂ may be formed of a p-channel MOS TFT.

In the pixel circuit array section 13, each signal line DTL is connected to an output end (not shown) of the signal line drive circuit 23, and to a drain electrode (not shown) of the write transistor Tr₂. Each write line WSL is connected to an output end (not shown) of the write line drive circuit 24, and to a gate electrode (not shown) of the write transistor Tr₂. Each power line PSL is connected to an output end (not shown) of the power line drive circuit 25, and to a drain electrode (not shown) of the drive transistor Tr₁. A source electrode (not shown) of the write transistor Tr₂ is connected to a top gate electrode (not shown) of the drive transistor Tr₁ and to one end of the capacitance Cₛ. A source electrode (not shown) of the drive transistor Tr₁ and the other end of the capacitance Cₛ are connected to an anode electrode (not shown) of the organic EL element 11. A cathode electrode (not shown) of the organic EL elements 11 is connected to, for example, a ground line GND. A back-gate electrode (not shown) of the drive transistor Tr₁ is connected to the top gate electrode of the drive transistor Tr₁. That is, the top gate electrode of the drive transistor Tr₁ and the back-gate electrode thereof are electrically connected to each other, and thus have equal electric-potential to each other. The cathode electrode, which is used as a common electrode of the organic EL elements 11, is, for example, continuously formed and thus has a plate-like shape over the whole of the display region of the display panel 10.

Drive Circuit

Next, circuits within the drive circuit 20 provided in the periphery of the pixel circuit array section 13 will be described with reference to FIG. 1.

A video signal processing circuit 21 performs predetermined correction on a digital video signal 20A inputted from the outside, and outputs such a corrected video signal 21A to a signal line drive circuit 23. The predetermined correction includes gamma correction, overdrive correction and the like.

A timing generator circuit 22 controls the signal line drive circuit 23, the write line drive circuit 24, and the power line drive circuit 25 such that the circuits operate in conjunction with one another. The timing generator circuit 22, for example, outputs a control signal 22A to each of the circuits in response to (in synchronization with) a synchronizing signal 20B inputted from the outside.

The signal line drive circuit 23 applies an analog video signal corresponding to the video signal 21A to each signal line DTL in response to (in synchronization with) the inputted control signal 22A so that the analog video signal or a corresponding signal is written to a pixel circuit 14 as a selection object. Specifically, the signal line drive circuit 23 applies signal voltage V_{sig} corresponding to the video signal 21A to each signal line DTL for writing to the pixel circuit 14 as a selection object. Here, writing refers to applying a predetermined voltage to the top gate G1 of the drive transistor Tr₁.

For example, the signal line drive circuit 23 may output the signal voltage V_{sig} and voltage V_{ofs} to be applied to the top gate G1 of the drive transistor Tr₁ for stopping light emission of the organic EL element 11. The voltage V_{ofs} has a value (constant value) lower than a value of threshold voltage Vₑ₁ of the organic EL element 11. The signal voltage V_{sig} has a value such that at least part of gate-to-source potential difference V_{gs} of the drive transistor Tr₁ in a usable range is in a sub-threshold region of the drive transistor Tr₁ at least in a low gray level. The sub-threshold region generally refers to an operation region where the gate-to-source potential difference V_{gs} is lower than the threshold voltage. The signal voltage V_{sig} has a value such that at least part of gate-to-source potential difference V_{gs} of the drive transistor Tr₁ in a usable range has a value of 5 V or lower at least in a low gray level. Preferably, the signal voltage V_{sig} has a value such that at least part of gate-to-source potential difference V_{gs} of the drive transistor Tr₁ in a usable range has a value of 5 V or lower not only in a low gray level but also in intermediate and high gray levels.

The write line drive circuit 24 sequentially applies a selection pulse to a plurality of write lines WSL in response to (in synchronization with) an inputted control signal 22A so that a plurality of organic EL elements 11 and a plurality of pixel circuits 14 are sequentially selected. For example, the write line drive circuit 24 may output voltage Vₒₙ applied for turning on the write transistor Tr₂ and voltage V_{off} applied for turning off the write transistor Tr₂.

The power line drive circuit 25 sequentially applies a control pulse to a plurality of power lines PSL in response to (in synchronization with) an inputted control signal 22A so as to control start and stop of light emission of the organic EL elements 11. For example, the power line drive circuit 25 may output voltage V_{cch} applied so as to allow current flow into the drive transistor Tr₁ and voltage V_{ccL} applied so as not to allow current flow into the transistor Tr₁. The voltage V_{ccL} has a value (constant value) lower than a value of voltage (Vₑ₁+V_{ca}) as the sum of the threshold voltage Vₑ₁ of the organic EL element 11 and cathode voltage V_{ca} of the organic EL element 11. The voltage V_{ccH} has a value (constant value) equal to or higher than the value of the voltage (Vₑ₁+V_{ca}).

Operation of Display Device 1

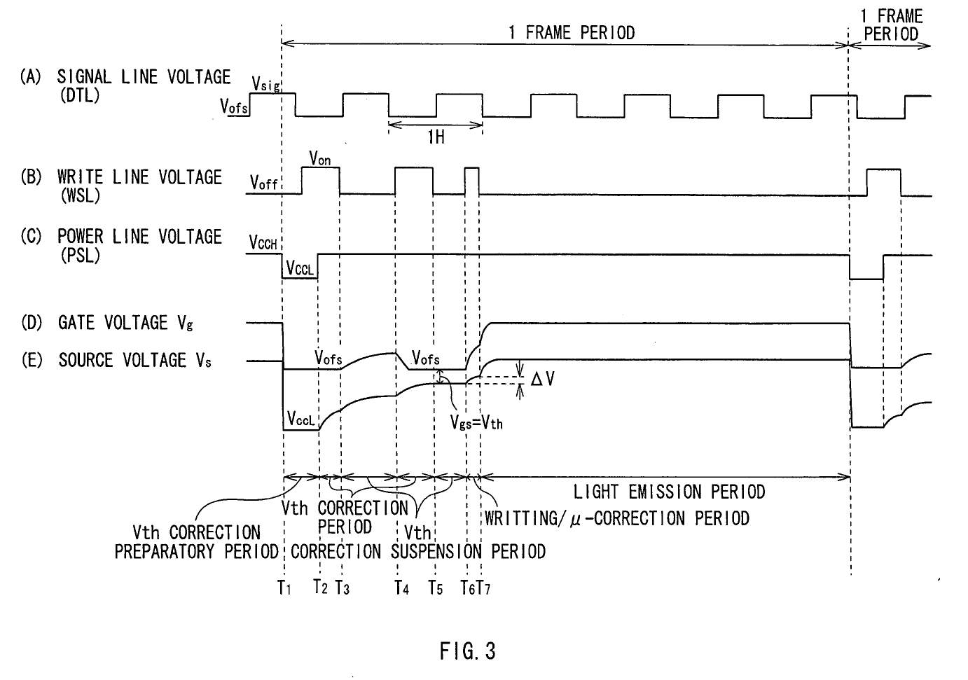

FIG. 3 shows an example of various voltage waveforms in the display device 1 being driven. In FIG. 3, (A) and (B) show an aspect where the signal line DTL is periodically applied with voltages V_{sig} and V_{ofs}, and the write line WSL is applied with voltages Vₒₙ and V_{off} at a predetermined timing, respectively. (C) shows an aspect where the power line PSL is applied with voltages V_{ccL} and V_{ccH} at a predetermined timing. (D) and (E) show an aspect where gate voltage V_{g} and source voltage Vₛ of the drive transistor Tr₁ are changed every moment in response to voltage application to each of the signal line DTL, the write line WSL and the power line PSL.

Vₜₕ Correction (Threshold Correction) Preparatory Period

First, Vₜₕ correction is prepared. Specifically, the power line drive circuit 25 lowers voltage of the power line PSL from V_{ccH} to V_{ccL} (T₁). Thus, the source voltage Vₛ becomes equal to V_{ccL}, so that the organic EL element 11 stops emitting light, and the gate voltage V_{g} becomes equal to (V_{ccL}+V_{gs0}) assuming that V_{gs} is V_{gs0} at light emission. Next, when voltage of the signal line DTL is V_{ofs}, and voltage of the power line PSL is V_{ccL}, the scan line drive circuit 24 increases voltage of the write line WSL from V_{off} to Vₒₙ.

First Vₜₕ Correction Period

Next, Vₜₕ correction is performed. Specifically, when voltage of the signal line DTL is V_{ofs}, and voltage of the write line WSL is Vₒₙ, the power line drive circuit 25 increases voltage of the power line PSL from V_{ccL} to V_{ccH} (T₂). Thus, current I_{d} flows between the drain and source of the drive transistor Tr₁, so that the source voltage Vₛ is increased. Then, the write line drive circuit 24 lowers voltage of the write line WSL from Vₒₙ to V_{off}, and then the signal line drive circuit 23 changes voltage of the signal line DTL from V_{ofs} to V_{sig} (T₃). Thus, the gate of the drive transistor Tr₁ turns into floating, so that Vₜₕ correction is suspended.

First Vₜₕ Correction Suspension Period

During suspension of Vₜₕ correction, sampling of voltage of the signal line DTL is performed in a row (pixel) different from a row (pixel) subjected to the previous Vₜₕ correction. When Vₜₕ correction is insufficient, namely, when potential difference V_{gs} between the gate and source of the drive transistor Tr₁ is larger than the threshold voltage Vₜₕ of the drive transistor Tr₁, the following occurs. That is, even during the Vₜₕ correction suspension period, current I_{d} flows between the drain and source of the drive transistor Tr₁ in the row (pixel) subjected to the previous Vₜₕ correction, and thus the source voltage Vₛ increases, and gate voltage V_{g} also increases through coupling via the capacitance Cₛ.

Second Vₜₕ Correction Period

After the Vₜₕ correction suspension period has been finished, Vₜₕ correction is performed again. Specifically, when voltage of the signal line DTL is V_{ofs}, and Vₜₕ correction is enabled, the write line drive circuit 24 increases voltage of the write line WSL from V_{off} to Vₒₙ (T₄), so that the gate of the drive transistor Tr₁ is connected to the signal line DTL. At that time, when the source voltage Vₛ is lower than (V_{ofs}−Vₜₕ) (Vₜₕ correction is still not completed), current I_{d} flows between the drain and source of the drive transistor Tr₁ until the transistor Tr₁ is cut off (until the potential difference V_{gs} becomes equal to Vₜₕ). As a result, the capacitance Cₛ is charged to Vₜₕ, so that the potential difference V_{gs} becomes equal to Vₜₕ. Then, the write line drive circuit 24 lowers voltage of the write line WSL from Vₒₙ to V_{off}, and then the signal line drive circuit 23 changes voltage of the signal line DTL from V_{ofs} to V_{sig} (T₅). Thus, the gate of the drive transistor Tr₁ turns into floating, and therefore the potential difference V_{gs} may be kept to Vₜₕ regardless of magnitude of voltage of the signal line DTL. In this way, the potential difference V_{gs} is set to Vₜₕ, thereby even if the threshold voltage Vₜₕ of the drive transistor Tr₁ varies for each pixel circuit 14, variation in emission luminance among the organic EL elements 11 may be prevented.

Second Vₜₕ Correction Suspension Period

Then, the signal line drive circuit 23 changes voltage of the signal line DTL from V_{ofs} to V_{sig} in a second Vₜₕ-correction suspension period.

Writing and μ Correction Period

After the Vₜₕ correction suspension period has been finished, writing and μ correction are performed. Specifically, when voltage of the signal line DTL is V_{sig}, the write line drive circuit 24 increases voltage of the write line WSL from V_{off1} to Vₒₙ₁ (T₆), so that the gate of the drive transistor Tr₁ is connected to the signal line DTL. Thus, gate voltage of the drive transistor Tr₁ becomes equal to V_{sig}. Anode voltage of the organic EL element 11 is still lower than the threshold voltage Vₑ₁ of the element 11 in this stage, and therefore the organic EL element 11 is cut off. Therefore, current I_{d} flows into element capacitance (not shown) of the organic EL element 11, so that the element capacitance is charged, resulting in increase in source voltage Vₛ by ΔV, and eventually voltage difference V_{gs} becomes equal to V_{sig}+Vₜₕ−ΔV. In this way, writing and μ correction are concurrently performed. Since ΔV is increased with increase in mobility μ of the drive transistor Tr₁ , variation in mobility μ among pixel circuits 14 may be removed by reducing the voltage difference V_{gs} by ΔV before start of light emission.

Light Emission Period

Next, the write line drive circuit 24 lowers voltage of the write line WSL from Vₒₙ to V_{off} (T₇). Thus, the gate of the drive transistor Tr₁ turns into floating, so that current I_{d} flows between the drain and source of the drive transistor Tr₁ while the voltage V_{gs} between the gate and source of the transistor Tr₁ is kept constant. As a result, the source voltage Vₛ increases, and accordingly gate voltage of the drive transistor Tr₁ increases, and consequently the organic EL element 11 starts to emit light with a desired luminance.

Operation

In the display device 1 of the embodiment, on/off control of the pixel circuit 14 is performed for each pixel 12, and drive current is thus injected into an organic EL element 11 of the pixel 12 as above, which causes recombination of holes and electrons, leading to light emission. Such emitted light is transmitted by electrodes and the like of the organic EL element 11 and then extracted to the outside. As a result, an image is displayed on the display panel 10.

Advantage

In an organic EL display device in the past, for example, size of the drive transistor Tr₁ has been increased to reduce the gate-to-source voltage V_{gs} of the drive transistor Tr₁, thereby low power consumption has been achieved. However, since such increase in size of the drive transistor Tr₁ is against the trend of high resolution, there has been a limitation in increase in size of the drive transistor Tr₁.

In the embodiment, a dual-gate transistor is used as the drive transistor Tr₁, and a unique characteristic of the dual-gate transistor is used to overcome the above difficulty. The unique characteristic is described below in comparison with a characteristic of a bottom-gate transistor.

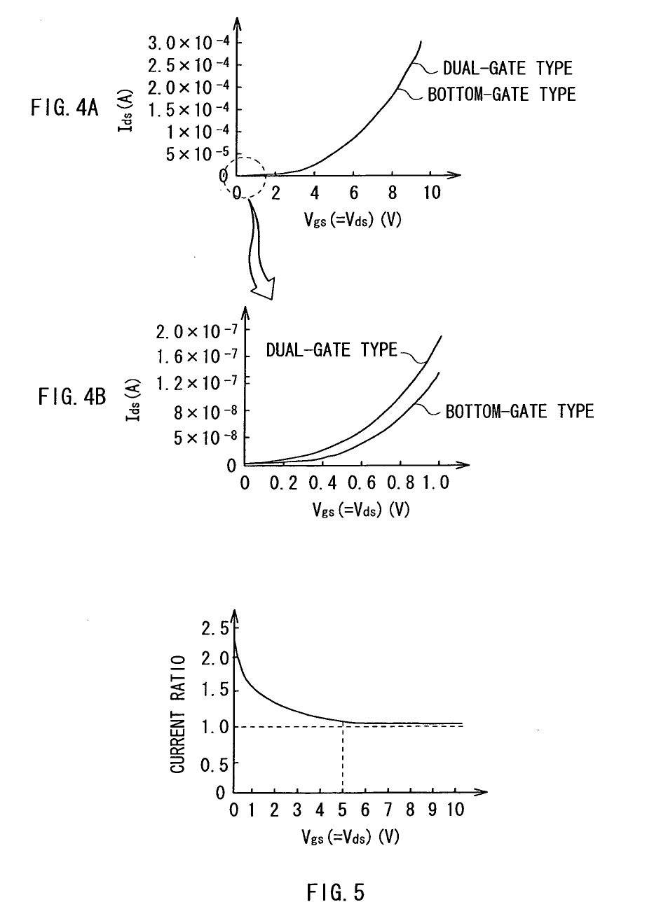

FIGS. 4A and 4B show an example of an I_{d}−V_{gs} characteristic in a saturated region of each of the dual-gate and bottom-gate transistors. FIG. 4B shows an area enclosed by a broken-line circle in FIG. 4A (part of a so-called sub-threshold region) in an enlarged manner. FIG. 5 shows a relationship between V_{gs} and a current ratio (a current value of the dual-gate transistor to a current value of the bottom-gate transistor) by using the I_{d}−V_{gs} characteristics of FIG. 4A. FIGS. 4A and 4B and FIG. 5 show results on the dual-gate and bottom-gate transistors that have been subjected to the threshold correction.

FIGS. 4A and 4B and FIG. 5 reveal that I_{d}−V_{gs} characteristics are not significantly different between the dual-gate and bottom-gate transistors in a high V_{gs} region. FIG. 5 reveals that the current ratio is slightly larger than 1 in the high V_{gs} range. This is because the top-gate electrode of the drive transistor Tr₁ is electrically connected to the back-gate electrode thereof, so that a channel is formed not only on a top-gate G1 side but also on a back-gate G2 side.

In a low V_{gs} range, specifically, in a range of V_{gs} of 5 V or lower, increase rate of I_{d} is large in the dual-gate transistor compared with in the bottom-gate transistor. In particular, difference in increase rate of I_{d} between the transistors increases with reduction in V_{gs} in the range of V_{gs} of 5 V or lower.

This reveals that when a transistor is used as a switching element, namely, when V_{gs} of around 10 V is used, whether the transistor is a dual-gate transistor or a bottom-gate transistor, there is no significant difference in the I_{d}−V_{gs} characteristic. When a transistor is used as a switching element, V_{gs} of 5 V or lower is not used in order to avoid difficulties such as decrease in switching speed and variation in threshold voltage of the transistor.

In contrast, when a transistor is not used as a simple switching element, but used as, for example, a drive transistor within a pixel circuit of an organic EL display device, there is a large difference in the I_{d}−V_{gs} characteristic depending on whether the transistor is a dual-gate transistor or a bottom-gate transistor. For example, when the drive transistor is configured of a dual-gate transistor, the drive transistor may be driven at a low voltage by using V_{gs} of 5 V or lower.

In the embodiment, the above unique characteristic is used for current control using the drive transistor Tr₁. Specifically, signal voltage V_{sig} is applied to the pixel circuit 14 such that at least part of values of gate-to-source voltage V_{gs} of the drive transistor Tr₁ in a usable range are in the sub-threshold region of the drive transistor Tr₁. For example, the signal voltage V_{sig} is applied to the pixel circuit 14 such that the gate-to-source voltage V_{gs} of the drive transistor Tr₁ is 5 V or lower. Thus, the gate-to-source voltage V_{gs} of the drive transistor Tr₁ may be reduced without increasing size of the drive transistor Tr₁. Thus, lower power consumption may be achieved without disturbing high resolution.

For example, when the signal voltage V_{sig} is applied to the pixel circuit 14 such that the gate-to-source voltage V_{gs} of the drive transistor Tr₁ is 5 V or lower in a low gray level, the amount of power consumption may be reduced at a pixel displayed with the low gray level. Furthermore, for example, when the signal voltage V_{sig} is applied to the pixel circuit 14 such that the gate-to-source voltage V_{gs} of the drive transistor Tr₁ is 5 V or lower not only in the low gray level but also in intermediate and high gray levels (namely, in all gray levels), the amount of power consumption may be reduced at all pixels.

### Module and Application Examples

Hereinafter, application examples of the display device described in the embodiment will be described. The display device according to the embodiment may be applied to a display device of each electronic device in any field, the electronic device including a television apparatus, a digital camera, a notebook personal computer, a mobile terminal such as mobile phone, or a video camera, for displaying an image or a video picture based on an externally-inputted or internally-generated video signal.

Module

The display device 1 according to the embodiment may be built in various electronic devices such as application examples 1 to 5 described later, for example, in a form of a module shown in FIG. 6. In the module, for example, a region 210 exposed from a sealing substrate 32 is provided in one side of a substrate 31, and external connection terminals (not shown) are formed in the exposed region 210 by extending wirings of a drive circuit 20. The external connection terminals may be attached with a flexible printed circuit (FPC) 220 for input or output of signals.

### Application Example 1

FIG. 7 shows appearance of a television apparatus using the display device 1 according to the embodiment. The television apparatus has, for example, an image display screen 300 including a front panel 310 and filter glass 320, and the image display screen 300 is configured of the display device 1 according to the embodiment.

### Application Example 2

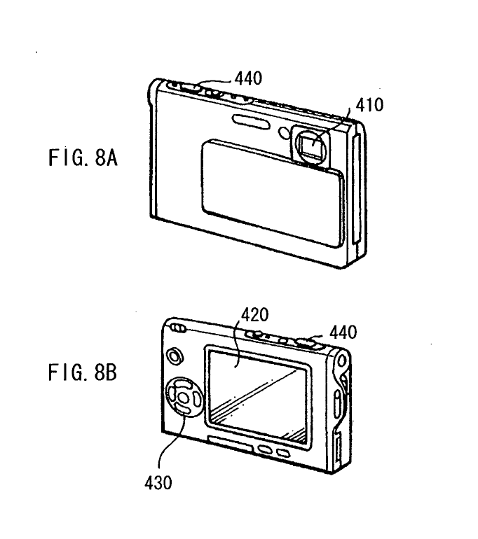

FIGS. 8A and 8B show appearance of a digital camera using the display device 1 according to the embodiment. The digital camera has, for example, a light emitting section for flash 410, a display 420, a menu switch 430 and a shutter button 440, and the display 420 is configured of the display device 1 according to the embodiment.

### Application Example 3

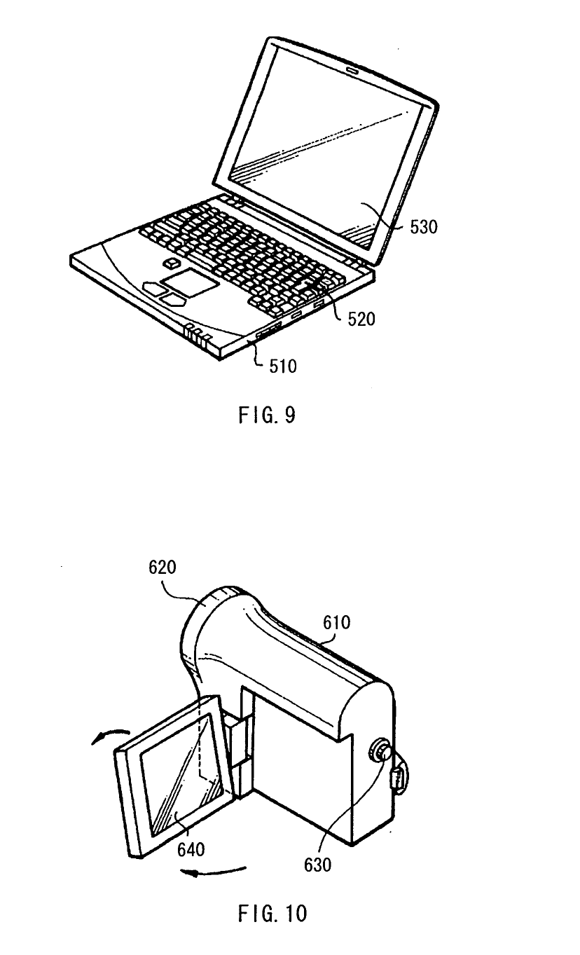

FIG. 9 shows appearance of a notebook personal computer using the display device 1 according to the embodiment. The notebook personal computer has, for example, a body 510, a keyboard 520 for input operation of letters and the like, and a display 530 for displaying images, and the display 530 is configured of the display device 1 according to the embodiment.

### Application Example 4

FIG. 10 shows appearance of a video camera using the display device 1 according to the embodiment. The video camera has, for example, a body 610, an object-shooting lens 620 provided on a front side-face of the body 610, a start/stop switch 630 for shooting, and a display 640. The display 640 is configured of the display device 1 according to the embodiment.

### Application Example 5

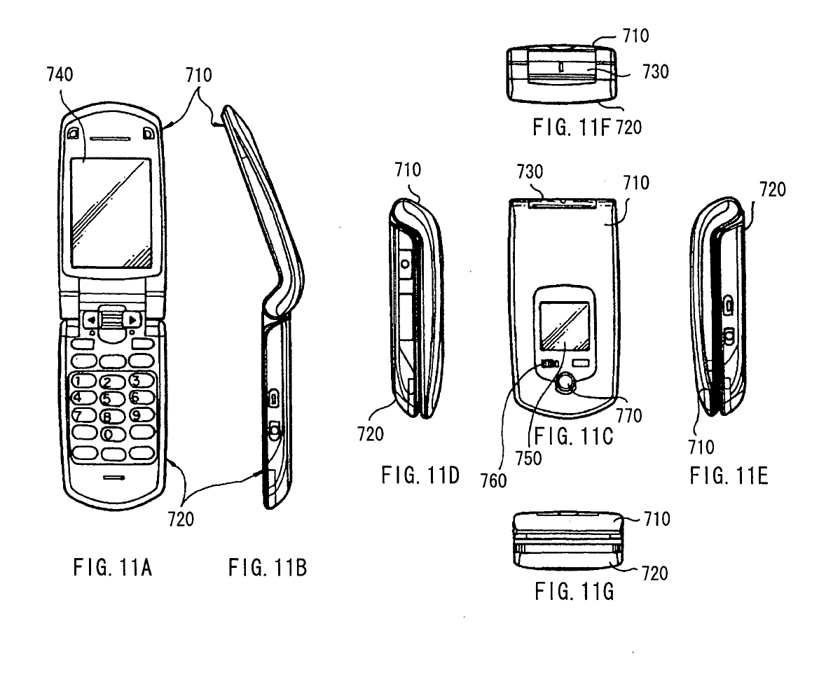

FIGS. 11A to 11G show appearance of a mobile phone using the display device 1 according to the embodiment. For example, the mobile phone is assembled by connecting an upper housing 710 to a lower housing 720 by a hinge 730, and has a display 740, a sub display 750, a picture light 760, and a camera 770. The display 740 or the sub display 750 is configured of the display device 1 according to the embodiment.

While the invention has been described with the embodiment and application examples hereinbefore, the invention is not limited to the embodiment and the like, and may be variously modified or altered.

For example, while the embodiment and the like have been described with a case where the display device 1 is an active-matrix display device, a configuration of the pixel circuit 14 for active matrix drive is not limited to that described in the embodiment, and a capacitive element or a transistor may be added to the pixel circuit 14 as necessary. In such a case, a drive circuit to be necessary may be provided in addition to the signal line drive circuit 23, the write line drive circuit 24, and the power line drive circuit 25 in correspondence to change in pixel circuit 14.

Moreover, while the signal line drive circuit 23, the write line drive circuit 24, and the power line drive circuit 25 are driven under control of the timing generator circuit 22 in the embodiment and the like, the drive circuits may be driven under control of another circuit. In addition, the signal line drive circuit 23, the write line drive circuit 24, and the power line drive circuit 25 may be controlled by hardware (circuit) or software (program).

Moreover, while the pixel circuit 14 has a configuration of 2Tr1C in the embodiment and the like, the pixel circuit 14 may have any configuration other than 2Tr1C as long as the configuration includes a dual gate transistor connected in series to the organic EL element 11.

Moreover, while a case where the drive transistor Tr₁ and the write transistor Tr₂ is formed of an n-channel MOS thin film transistor (TFT) has been exemplified in the embodiment and the like, the transistors may be formed of a p-channel transistor (for example, p-channel MOS TFT). In such a case, it is preferable that one of a source and a drain of the transistor Tr₂, being not connected to the power line PSL, and the other end of the capacitance Cₛ are connected to the cathode of the organic EL element 11, and the anode of the EL element 11 is connected to GND.

The present application contains subject matter related to that disclosed in Japanese Priority Patent Application JP 2009-266735 filed in the Japan Patent Office on Nov. 24, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. A display device comprising:
a display section having sets of light emitting elements and pixel circuits arranged two-dimensionally; and
a drive section driving each of the pixel circuits based on a video signal,
wherein the pixel circuit has a dual-gate first transistor having a first gate and a second gate and controlling electric current flowing into each of the light emitting elements, and a second transistor writing a signal voltage into the first gate in accordance with the video signal, and
the drive section applies the signal voltage to the pixel circuit such that at least part of values of gate-to-source voltage of the first transistor in a usable range is 5 V or lower.

2. The display device according to claim 1,
wherein the drive section performs threshold correction to the first transistor and then applies the signal voltage to the pixel circuit.

3. The display device according to claim 1,
wherein the first gate and the second gate are electrically connected to each other, and have electric potential equal to each other.

4. A method of driving a display device, comprising steps of:
preparing a display device including a display section having sets of light emitting elements and pixel circuits arranged two-dimensionally, and a drive section driving each of the pixel circuits based on a video signal, wherein the pixel circuit has a dual-gate first transistor having a first gate and a second gate and controlling electric current flowing into each of the light emitting elements, and a second transistor writing a signal voltage into the first gate in accordance with the video signal; and
using the drive section to apply the signal voltage to the pixel circuit such that at least part of values of gate-to-source voltage of the first transistor in a usable range are 5 V or lower.

5. An electronic device comprising:
a display device,
wherein the display device includes
a display section having sets of light emitting elements and pixel circuits arranged two-dimensionally, and
a drive section driving each of the pixel circuits based on a video signal,
wherein the pixel circuit has a dual-gate first transistor having a first gate and a second gate and controlling electric current flowing into each of the light emitting elements, and a second transistor writing a signal voltage into the first gate in accordance with the video signal, and
the drive section applies the signal voltage to the pixel circuit such that at least part of values of gate-to-source voltage of the first transistor in a usable range are 5 V or lower.

6. A display device comprising:
a display section having sets of light emitting elements and pixel circuits arranged two-dimensionally,
wherein each of the pixel circuits has a dual-gate transistor controlling electric current flowing into each of the light emitting elements, and
at least part of values of gate-to-source voltage of the transistor in a usable range are 5 V or lower.
